(19) United States
(12) Patent Application Publication
(10) Pub. No.: US 2015/0261710 A1
(43) Pub. Date: Sep. 17, 2015

(54) LOW-PROFILE HALF LENGTH PCI EXPRESS FORM FACTOR EMBEDDED PCI EXPRESS MULTI PORTS SWITCH AND RELATED ACCESSORIES

(71) Applicant: Emilio Billi, San Jose, CA (US)

(72) Inventor: Emilio Billi, San Jose, CA (US)

(21) Appl. No.: 14/214,580

(22) Filed: Mar. 14, 2014

(51) Int. Cl. G06F 13/40

(52) U.S. Cl. CPC G06F 13/4022

(57) ABSTRACT

A low-profile half size PCI Express form factor PCI Express multiport switch assembly that can be internally hosted by standard servers and workstations having up to six board-mount connectors that allow for the right angle connection of cable connectors to a PCI Express (“PCIe”) device with PCIe network and cluster capabilities. This solution enables all the features supported by the PCIe switching technology comprising typical PCIe NTB applications. All these features enables the use of the PCI Express multiport switch in high density server environment eliminating the needing of additional external hardware, optimizing the space and the cabling among the servers if the on board switch chip is able to support this application. Specific add on cards complete the solution enabling different configurations and solutions.

### CROSS REFERENCE TO RELATED APPLICATIONS

The present application is a continuation-in-part of co-pending U.S. Patent Provisional Application Ser. No. 61/786,551 entitled “Low-Profile Half Length PCI Express Multi Ports Switch and Related Accessories”, filed Mar. 15, 2013.

### BACKGROUND OF THE INVENTION

1. Field of Invention

The present invention is directed to a low-profile half size PCI Express form factor PCI Express multiport switch assembly that can be internally hosted by standard servers and workstations, having up to six board-mount connectors that allows for the right angle connection of cable connectors to a PCI Express (“PCIe”) devices, using the well known PCIe over cable technology, such as external PCIe cards like, but not limited to, PCI based accelerators, PCIe based FPGAs cards, network adapters like Ethernet cards, Infiniband cards, USB card, FC cards and so on, HDD and multiport expansion box and some related accessories that complete the solution enabling all the features supported by the PCIe switching technology comprising typical PCIe NTB applications like high availability and point to point communications, if supported by the switch chip itself. All these features enable the use of the PCI Express multiport switch in a PCIe cluster environment as a PCIe NIC eliminating the needing of additional external hardware, optimizing the space and the cabling among the servers, if the on board switch chip is able to support this application.

2. Description of Related Art

Traditional PCIe switches are designed to be fully compliant with the PCI-SIG PCI Express over cable standard in term of connectors type, this result is a big switch equipment, most of the time based on a 19″ enclosure, that must be placed externally of the computers that use them. Also the cables are normally based on AWG 26 cables resulting in big and heavy cables. All these two aspects comport loosing space at rack level, complex cables management and higher cost with consequent limitation in general purpose PCIe based switch adoption. Our solution consists in creating a card that adopts small connectors ready to support PCIe, Gen. 1, 2 and 3 types and futures implementations of electric signals over cable, allowing up to six connectors to fit in the space required by the PCIe low profile card specification. The solution can be realized in a configuration of 6 PCIe ports by 4x or can be combined by 2 in order to have up to 3 PCIe ports by 8x. This solution enable an enormous integration in terms of I/O density in modern server and can be used to multiply the numbers of total PCIe I/O available in a standard datacenter without using external switch equipment that needs additional space. Considering that most modern servers used in datacenters are designed to accommodate only low-profile PCIe cards, using standard connectors would not enable the realization of the previous concept.

Thus, there is a need in the art for a PCIe card assembly with an increased number of board-mount connectors that allow for the connection to a corresponding number of cable connectors that can be used into the standard server without adding external equipment to provide the signal switching required to be able to connect multiple external PCIe based I/O to a standard server. This compact switch enables the connection of many external PCIe based I/O to the servers that normally are not able to accommodate more than a single PCIe device without using external equipment, like standard 19″ rack mount PCIe switches, this solution is extremely useful, for example, to connect multiple PCIe based SDDs expander, or multiple GPGPU external boxes, to existing servers that normally can be equipped only one single PCIe card enabling scale up I/Os in a very easy way. Multiple PCIe SSDs can be used to accelerate the application running on existing servers with enormous benefit in term of increased server efficiency and TCO reduction.

There is also the need in the art for a PCIe card assembly, that can be fitted inside any server, with an increased number of board-mount connectors that allow for the connection of multiple servers without using external hardware according with the emerging PCIe clustering technology, enabling the creation of complex architecture with many interesting features like high availability between multiple servers without adding external hardware in the rack system as happens today, reducing the complexity of using external 19″ switches and introducing smaller and more optimized cables that on the contrary of today PCIe clustering one are easy to manage also in high density server scenarios.

### SUMMARY

Embodiments of the invention provide a low-profile half size PCIe switch assembly with up to six board-mount connectors used for external PCIe connection by cables and one internal PCIe PCB based standard PCIe slot connector at least in one configuration allowed by the PCI-SIG PCIe specifications, i.e. 1x, 4x, 8x, 16x, connected to a PCIe switch logic mounted inside the board that allows the creation of low-profile half size embedded PCIe switch with up to six port by 4x or a 3 port by 8x, combining the six port into groups by 2, or a combination of both that can be used in any kind of existing servers equipped by at least a PCIe internal slot compliant with switch PCB PCIe slot connector in combination with many accessories that enable the creation of many different servers and I/Os architectural scenarios in a very easy way.

In general, in one aspect, embodiments of the invention relate to a low-profile half size embedded PCIe switch assembly and some related accessories. The switch assembly comprises, among other things, at least one PCIe switch chip coupled to up to 6 board-mount connectors contains a total of 6 PCIe ports that can be configured in any combination according with the specific features of the PCIe switch chip, features used for external switch to switch or switch to PCIe end point connection and an internal standard PCIe slot connector.

In some embodiments, the board mount connectors can be dived into two groups of connectors one internal and one external.

In some embodiments, the internal connector can be connected to a secondary card to convert the internal connectors into external ones.

In some embodiments, the internal connector can be connected internally to a compliant PCIe equipment through an opportune adapter or to another equivalent switch.

In some embodiments the switch is connected to some accessories that are, passive PCIe internal Card, passive internal/external raiser card, passive adapter from internal board connector to external connectors.

In general, in another aspect, embodiments of the invention relate to a low-profile half size embedded PCIe switch assembly. The switch assembly comprises, among other things, up to 6 board-mount connector used for cable connection an internal PCB PCIe slot connector, an on board PCIe switch chip logic and some additional accessories that enables many different type of connectivity.

Additional and/or alternative aspects of the invention will become apparent to those having ordinary skill in the art from the accompanying drawings and following detailed description of the disclosed embodiments.

### BRIEF DESCRIPTION OF THE DRAWINGS

The apparatus of the invention is further described and explained in relation to the following figures of the drawing wherein.

FIG. 1 is a top view of the low-profile half size embedded PCIe switch in the four external and two internal ports connector version.

FIG. 2 is an isometric view of the low-profile half size embedded PCIe switch in the four external and two internal ports connector version.

FIG. 3 is a top view of the low-profile half size embedded PCIe switch in the all external six port connector.

FIG. 4 is an isometric perspective view of the low-profile half size embedded PCIe switch in the all external six port connector version.

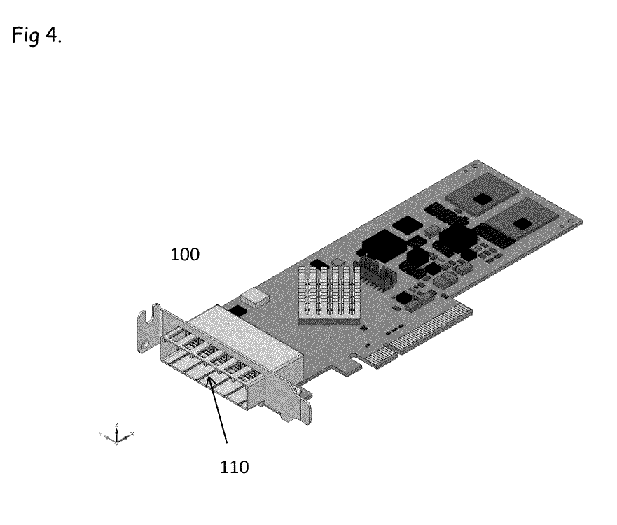

FIG. 5 is a top view of the passive internal raiser card.

FIG. 6 is a top view of the passive adapter from internal board connector to external connectors.

FIG. 7 is an isometric view of the passive adapter from internal board connector to external connectors.

### DETAILED DESCRIPTION OF THE PREFERRED EMBODIMENTS

The figures described above and the written description of specific structures and functions below are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location, and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the invention or the appended claims.

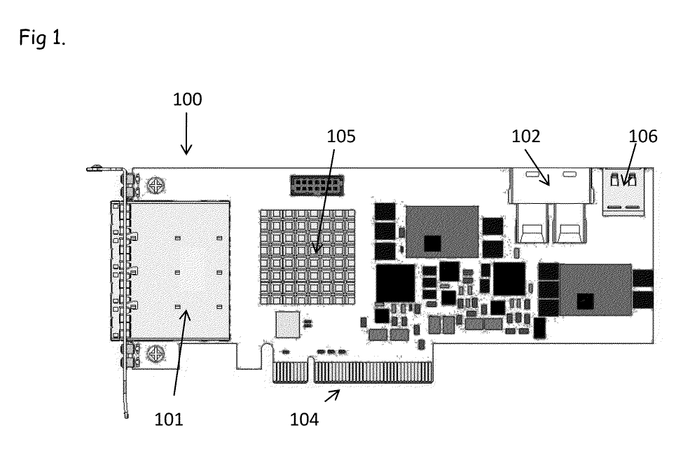

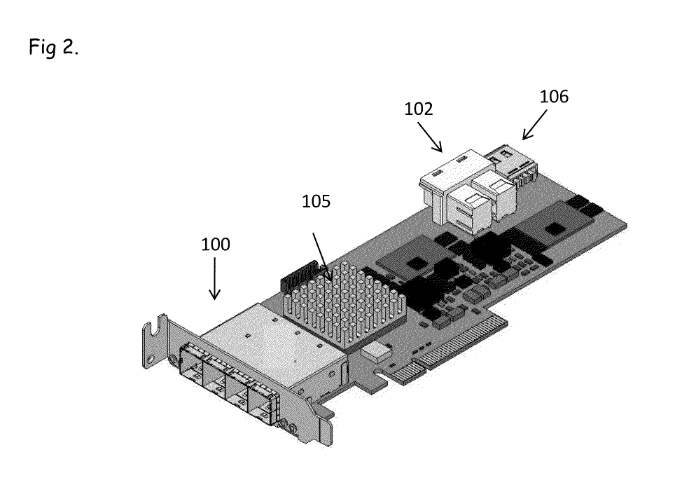

As shown in at least FIGS. 1, 2, low-profile half size PCIe switch assembly (100) comprises six board-mount connectors (101 and 102), 4 cable connectors (101) for external connection to other PCIe devices and other PCIe switches and 2 cable connectors internal (102) for specific applications and configuration using specific add on, a PCIe bracket (103) permit the retention of the switch in a standard low profile server slot and a PCIe PCB 8x slot (104) is used for the connection with the root complex present in the server using an internal PCIe compliant slot. A PCIe switch chip (105) is used to realize the connections between the different connectors realizing the scope of the invention. The form factor is strictly a low profile half size PCIe card.

Low profile PCIe add-in cards are governed by the industry standards set forth in the PCI Express® Card Electromechanical Specification. In particular the standard sets forth height, length, width, and other form factor parameters in the section titled “Add-in Card Form Factors and Implementation.”

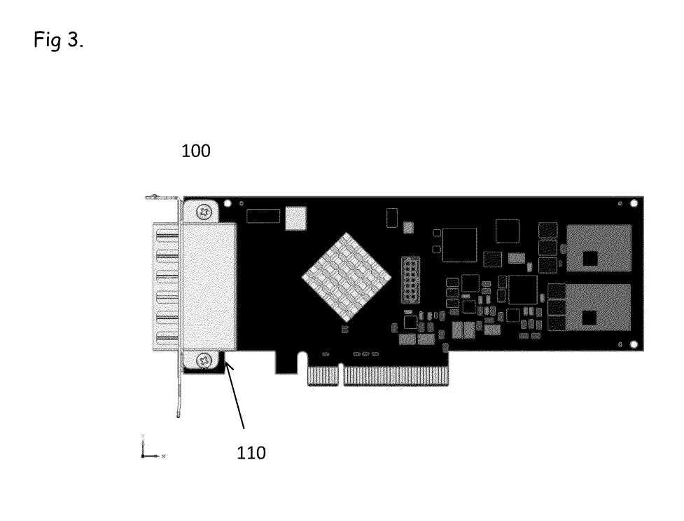

As shown in FIG. 3, the switch 100 can be realized using a different type of connectors in order to realize a six ports all external version of the low-profile half size PCIe switch assembly using a different type of connectors (110) designed specifically for this scope. The functionalities are the same of a switch described in FIGS. 1 and 2. The board mount connectors (110) have a six external connectors for cable connections, in this case the switch cannot have internal board mount connectors like FIG. 1 102.

As shown in FIG. 1,2 in one preferred embodiment, each switch can be equipped with a secondary power connector (106) that can be used instead of the standard power available through the PCIe PCB slot connector (104) and in case of main power failure due to a server down to guaranty the switch alimentations necessary for some high availability configurations.

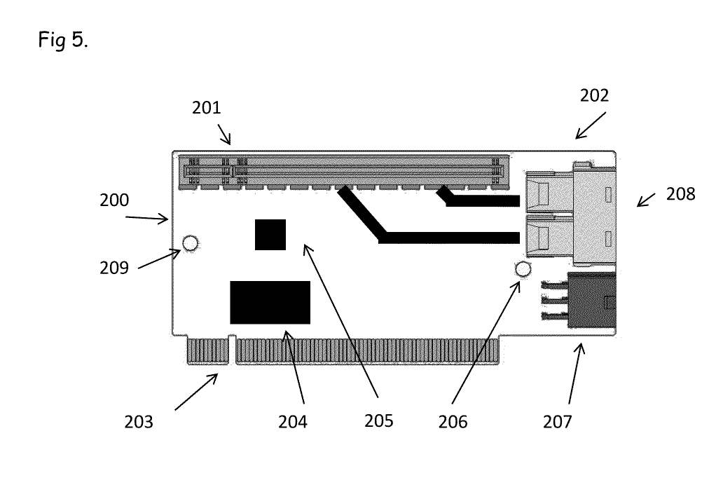

The FIG. 5 represents the top view of the internal passive riser card that is used to connect standard PCIe cards to the switch.

The riser (200), in one preferred embodiment, is composed by a PCIe compliant slot (201) directly connected to the on board cable connector (208). This connector can have 2 ports that can be used as two separate PCIe by 4x ports or in combination creating a single PCIe port by 8x. The configuration and use of the ports can be driven by the final application of the riser (200). The connector (208) is fully compliant with the connector used in FIG. 1. 102. The riser card uses an internal clock generator and PCIe reset (205) to guaranty the PCIe functionality to any PCIe end point that will be connected to the connector slot (201). The component (204) is used to provide the power switching from the 12v coming from the power connector (207) required by the PCIe connector slot as described by the PCIe PCI-SIG standard.

The internal passive riser FIG. 5 200 in one preferred embodiment uses a standard PCB PCIe slot (203) only as mechanical retention system in application where this retention can be used. The PCIe slot (203) is not electrically connected to anything inside the board (200). In other cases the holes (206 and 209) can be used to retain the card 200.

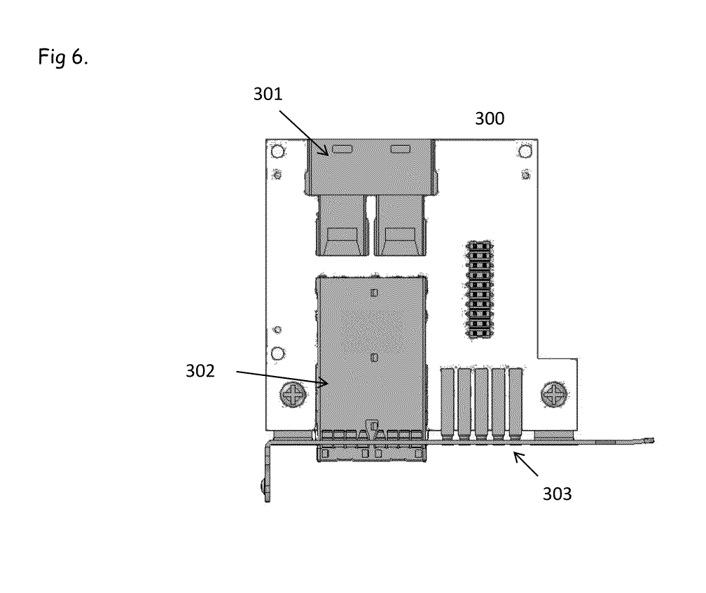

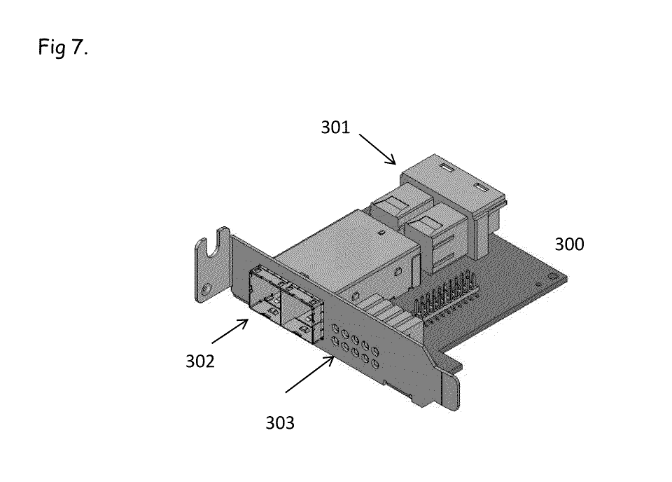

FIGS. 6 and 7 show in one preferred embodiment an adapter card (300) used to convert the board mount internal connector FIG. 1 102 using the compliant board mount connector 301 into the external board mount connector 302 that is compliant with the one in FIG. 1. 101, in one preferred embodiment the card (300) can be equipped with LED (303) that can be used to show the status of the single channel and other switch chip (FIG. 1 105) status.

The present invention is related to a low-profile half size PCIe switch assembly (100) that can have up 6 ports PCIe by 4x that can be used to connect multiple external PCIe end point and equipment using specific add on. A low-profile half size PCIe switch assembly with six connectors allows the implementation of all the feature of a standard PCIe switch normally hosted in a 19″ rack mount enclosure in a standard low profile PCIe slot that normally is present in every modern server. This allow the scale up of the server I/Os without impact on the rack space available and in the case of a PCIe based cluster this solution enables the creation of a PCIe clusters with complex topologies, according with the new emerging PCIe clustering technology that have well-known and documented benefits in terms of high availability and low latency compared with the traditional external switch based topologies. For example, in many applications that need to be accelerated using SSDs in a single 1U high density server you have only one PCIe slot so you can fit only one PCIe SSDs adapter using the existing PCIe slot in the server, if you need more PCIe slot you have to use an external 19″ PCIe switch and an expansion BOX, using our solution you can connect up to 6 expansion boxes without adding an external switch or creating a small PCIe cluster connecting directly many servers and I/Os using the different ports available.

Stated in other terms, the present invention's use of a low profile half size PCIe form factor PCIe switch with six connectors provides the ability to implement a high density embedded PCIe switch environment with all the features present in standard 19″ rack mount PCIe switch on the market enabling the scale up of the server's I/Os in a very easy way, the creation of complex architecture using all the features provided by PCIe included the PCIe clustering capabilities provided by the use of the PCIe NTB implementation thanks to the use of a specific add on. A cluster network is a type of network system comprising multiple computer systems that are connected to one another in a specific topology. Each computer system serves as a node in the topology. The present invention provides a PCIe card assembly that is capable of fitting up to six connectors (each with eight differential pairs) within the low profile PCIe standard bracket and a series of add on that permit to create different configuration connecting together multiple server, multiple I/Os in different ways. As a result, the present invention provides the ability to use a combination of PCIe I/Os and PCIe clustering with different configuration without using external PCIe switches optimizing the rack space and introducing smaller PCIe ready cables that are more network oriented, easier to manage and perfect for a standard datacenter environment. Currently, other PCIe switches assemblies are unable to provide the ability to implement a complete embedded PCIe switch on a high-density server without adding external switches that uses big cables. Therefore, the present invention provides improved networking benefits associated with the use of a ready to use PCIe network capability for small network provided by NTB built in into the switch core, providing well known benefit including higher data transmission rate in point to point communications, CPU to CPU direct communications, lower latency, lower infrastructure costs, lower power consumption, lower operating costs, simplified cabling, improved fault tolerance, improved reliability and flexibility using the specific add on to create any kind of I/Os configuration without adding external switches.

The present invention enables easy scale up I/Os in high density server and enables the creation of new architectures, using specific add on, in a easier way than using traditional PCIe switches and cables.

1. A low-profile half size PCI Express form factor PCI Express multiport switch assembly that can be internally hosted by standard servers and workstations comprising:
at least one board-mount connector for external PCIe cable connection;
at least one PCB PCIe standard slot compliant with the PCI-SIG specification.

2. The low-profile half size PCI Express form factor PCI Express multiport switch assembly of claim 1 wherein the mount board cable connectors can be or internal type or external type or present in both combination external type and internal type.

3. The low-profile half size PCI Express form factor PCI Express multiport switch assembly of claim 1 wherein the I/Os and network capabilities con be implemented using the implementation of NTB features.

4. A series of add on boards that can be connected to and used in combination with the low-profile half size PCI Express form factor PCI Express multiport switch assembly including at least:
a) A passive riser card with a PCIe PCB female slot with all the features described into the PCIe PCI-SIG related specifications.
b) A passive board used as adapter between internal cable connectors and external cable connectors including in a possible embodiment at least one LED for switch status monitoring.
c) A passive board comprising a PCIe standard male slot and at least one board mount external cable connector.

5. The low-profile half size PCI Express form factor PCI Express multiport switch assembly of claim 1 in any combination with the add ons at claim 4.
